(19) United States
(12) Patent Application Publication
(10) Pub. No.: US 2023/0312900 A1
(43) Pub. Date: Oct. 5, 2023

(54) FOAMABLE RESIN COMPOSITION, MOLDED RESIN FOAM, AND PRODUCTION METHOD THEREFOR

(71) Applicant: TOYODA GOSEI CO., LTD., Kiyosu-shi (JP)

(72) Inventors: Koki TANAKA, Kiyosu-shi (JP); Yasushi NIMI, Kiyosu-shi (JP); Kazuyoshi FUJIMOTO, Kiyosu-shi (JP)

(21) Appl. No.: 18/183,420

(22) Filed: Mar. 14, 2023

(30) Foreign Application Priority Data
Mar. 29, 2022 (JP) 2022-053737

(51) Int. Cl. C08L 25/06; C08J 9/232

(52) U.S. Cl. CPC C08L 25/06; C08J 9/232; C08J 2203/22; C08J 2203/182; C08J 2325/10; C08J 2423/16

(57) ABSTRACT

A foamable resin composition includes a styrenic thermoplastic elastomer and a dynamically crosslinked thermoplastic elastomer in a total amount of 100 parts by mass. An amount of the dynamically crosslinked thermoplastic elastomer is 10 to 40 parts by mass. The composition further includes high-temperature expandable microcapsules and low-temperature expandable microcapsules in a total amount of 25 to 50 parts by mass relative to 100 parts by mass of the elastomers, and an amount of the low-temperature expandable microcapsules is 17 to 67% by mass relative to the total amount of the two types of microcapsules.

### TECHNICAL FIELD

The present invention relates to a foamable resin composition, a molded resin foam, and a production method therefor.

### BACKGROUND ART

Molded urethane foam is used as the cushioning material of a console lid used in vehicles. Since urethane foam is expensive, attempts have been made to replace urethane foam with foamed thermoplastic resin for cost reduction.

Patent Document 1 discloses a method involving kneading a composition containing an olefinic thermoplastic resin and thermally expandable microcapsules, adding a thermoplastic resin (e.g., a styrenic elastomer) to the composition, and molding a foam from the resultant mixture.

Patent Document 2 discloses a foamable thermoplastic elastomer composition containing an olefinic resin or rubber, thermally expandable microcapsules, a volatile composition (e.g., heptane, silica sol), and a thermoplastic resin (e.g., a styrenic elastomer).

Patent Document 3 discloses a molded foam produced by foaming of a foamable thermoplastic elastomer composition containing an olefinic resin or rubber, thermally expandable microcapsules, a silica sol, and a thermoplastic resin (e.g., a styrenic elastomer).

### CITATION LIST

### Patent Documents

[Patent Document 1] Japanese Unexamined Patent Application Publication No. 2000-17103 (JP 2000-17103 A)
[Patent Document 2] Japanese Unexamined Patent Application Publication No. 2003-192825 (JP 2003-192825 A)
[Patent Document 3] Japanese Unexamined Patent Application Publication No. 2007-270157 (JP 2007-270157 A)

### SUMMARY OF THE INVENTION

### Technical Problem

However, according to the studies by the present inventors, difficulty is encountered in achieving the properties comparable to those of urethane foam (i.e., low specific gravity, low hardness, and low compression set) by only addition of thermally expandable microcapsules to a thermoplastic resin and a styrenic elastomer as described above. The reasons for this are considered as follows.

(1) Urethane foams through the reaction process of polyol isocyanate, which is in the form of liquid at a low temperature, and thus is easy to make it foam to a high degree and to lower the specific gravity thereof. In contrast, a thermoplastic resin needs to be foamed in a high-temperature molten state, and thus is difficult to make it foam to a high degree and to lower the specific gravity thereof.

(2) A thermoplastic resin is disadvantageous in terms of compression set properties under compression at a high temperature.

In view of the foregoing, an object of the present invention is to produce a molded resin foam that has thermoplasticity, low specific gravity, low hardness, and low compression set, and can serve as a substitute for urethane foam.

### Solution to Problem

[1] A foamable resin composition containing a styrenic thermoplastic elastomer and a dynamically crosslinked thermoplastic elastomer in a total amount of 100 parts by mass, wherein an amount of the dynamically crosslinked thermoplastic elastomer is 10 to 40 parts by mass, the composition further contains high-temperature expandable microcapsules and low-temperature expandable microcapsules in a total amount of 25 to 50 parts by mass relative to 100 parts by mass of the elastomers, and an amount of the low-temperature expandable microcapsules is 17 to 67% by mass relative to the total amount of the two types of microcapsules.

As used herein, the terms “high-temperature expandable microcapsules” and “low-temperature expandable microcapsules” respectively refer to microcapsules having a relatively high maximum expansion temperature and microcapsules having a relatively low maximum expansion temperature. The maximum expansion temperature refers to the temperature above which the shells burst, the foaming component escapes, and the microcapsules shrink.

[2] A method for producing a molded resin foam, the method including molding a foamable resin composition containing a styrenic thermoplastic elastomer, a dynamically crosslinked thermoplastic elastomer, high-temperature expandable microcapsules, and low-temperature expandable microcapsules at a temperature at which the high-temperature expandable microcapsules do not burst, but the low-temperature expandable microcapsules burst at least partially.

[3] A molded resin foam containing a styrenic thermoplastic elastomer, a dynamically crosslinked thermoplastic elastomer, high-temperature expandable microcapsules, and low-temperature expandable microcapsules, wherein the high-temperature expandable microcapsules expand but do not burst; the low-temperature expandable microcapsules expand and burst at least partially; and the resin foam has a specific gravity of 0.3 or less, an Asker C hardness of 45 or less, and a compression set (JIS K 6400-4, method A, compressibility: 50%) of 35% or less.

[Effects]

(A) The crosslinked rubber elasticity of the dynamically crosslinked thermoplastic elastomer mixed with the styrenic thermoplastic elastomer (i.e., base resin) provides a modified resin that is resistant to crushing at high temperature, resulting in low compression set and a reduction in sink marks (i.e., collapse due to shrinkage after foammolding), which tend to occur due to high-degree foaming and open cell formation during foam molding.

The amount of the dynamically crosslinked thermoplastic elastomer is adjusted to 10 to 40 parts by mass relative to 100 parts by mass of the elastomers, in order to achieve low compression set and low hardness. An amount of less than 10 parts by mass causes an increase in compression set, whereas an amount of more than 40 parts by mass may cause difficulty in achieving low hardness.

(B) In general, the process of foaming with thermally expandable microcapsules involves the use of only microcapsules that do not burst during molding, and thus may cause formation of closed cells, resulting in a hard molded foam. In contrast, the present invention involves the use of high-temperature expandable microcapsules that do not burst during molding in combination with low-temperature expandable microcapsules that burst at least partially during molding. Thus, the high-temperature expandable microcapsules form closed cells, and the burst low-temperature expandable microcapsules are connected together to form open cells, resulting in low hardness.

The total amount of the high-temperature expandable microcapsules and the low-temperature expandable microcapsules is adjusted to 25 to 50 parts by mass relative to 100 parts by mass of the elastomers, and the amount of the low-temperature expandable microcapsules is adjusted to 17 to 67% by mass relative to the total amount of these two types of microcapsules, in order to achieve low specific gravity and low hardness.

### Advantageous Effects of Invention

According to the present invention, there can be produced a molded resin foam that has thermoplasticity, low specific gravity, low hardness, and low compression set, and can serve as a substitute for urethane foam.

### BRIEF DESCRIPTION OF DRAWINGS

FIG. 1 is a micrograph of a cross-section of the molded resin foam of Example 3; and

FIG. 2 is a micrograph of a cross-section of the molded resin foam of Comparative Example 5.

### DESCRIPTION OF EMBODIMENTS

1. Styrenic Thermoplastic Elastomer (TPS: Thermoplastic Styrenic Elastomer)

No particular limitation is imposed on the type of TPS. Examples thereof include a TPS wherein the hard segment is polystyrene or polypropylene, and the soft segment is a styrene-butadiene-styrene block copolymer (SBS), a styrene-isoprene-styrene block copolymer (SIS), a styrene-ethylene-butylene-styrene block copolymer (SEBS) prepared by hydrogenation thereof, or a styrene-ethylene-propylene-styrene block copolymer (SEPS).

2. Dynamically Crosslinked Thermoplastic Elastomer (TPV: thermoplastic vulcanizate)

No particular limitation is imposed on the type of TPV. Examples thereof include a TPV wherein the hard segment is a polyolefin (e.g., polypropylene), and the soft segment is an olefinic crosslinked rubber (e.g., EPDM). Dynamic crosslinking is a process wherein a thermoplastic resin and a rubber are melt-kneaded in parallel with crosslinking of the rubber under shearing, and is in contrast to a common process wherein a rubber is statically crosslinked.

3. High-Temperature Expandable Microcapsule and Low-Temperature Expandable Microcapsule

Each of high-temperature expandable microcapsules and low-temperature expandable microcapsules, which serve as a foaming agent, is formed by enclosing a foaming component in a shell. No particular limitation is imposed on the material of the shell, and examples thereof include a thermoplastic resin (e.g., an acrylic resin). No particular limitation is imposed on the foaming component, and examples thereof include a liquid hydrocarbon.

4. Additional Component

Each of the foamable resin composition and molded resin foam of the present invention may further contain an additional component. Examples of the additional component include a filler, a colorant, and an antioxidant.

5. Formation of Molded Resin Foam

No particular limitation is imposed on the method of molding (foam molding), and examples of the method include injection foaming, press foaming, extrusion foaming, and blow foaming.

6. Application of Molded Resin Foam

No particular limitation is imposed on the application of the molded resin foam. Examples of suitable applications of the molded resin foam include cushioning materials for automobile interior parts (e.g., a console lid, an armrest, and a seat), and cushioning materials for furniture (e.g., a chair).

### Examples

[Preparation of Foamable Resin Composition]

Materials were formulated in amounts shown in Tables 1 and 2 below (the value of each amount is represented by parts by mass), to thereby prepare foamable resin compositions (samples 1 to 31).

Samples 1 to 7 correspond to a group wherein a selected foaming agent was mixed with TPS.

Samples 8 to 13 correspond to a group wherein the proportions of TPS and TPV were varied, and the proportions of high-temperature expandable microcapsules and low-temperature expandable microcapsules were maintained constant.

Sample 14 corresponds to a group wherein high-temperature expandable microcapsules were mixed with TPV.

Samples 15 to 31 correspond to a group wherein the proportions of TPS and TPV were maintained constant, and the proportions of high-temperature expandable microcapsules and low-temperature expandable microcapsules were varied.

TABLE 1

| | | Sample No. | | |
|---|---|---|---|---|
| | | 1 | 2 | 3 |
| | | Comparative | Comparative | Comparative |
| | | Example 1 | Example 2 | Example 3 |
| Formu- | TPS | 100 | 100 | 100 |
| lation | TPV | | | |
| (parts by | Chemical Foaming | 3 | 3 | |
| mass) | Agent | | | |
| | Low-temperature | | | |
| | Expandable | | | |
| | Microcapsules (a) | | | |
| | High-temperature | | 10 | 10 |
| | Expandable | | | |
| | Microcapsules (b) | | | |
| Note | a + b | | 10 | 10 |
| | a/(a + b) | | 0% | 0% |
| Property | Specific Gravity | 0.54 | 0.30 | 0.32 |
| | Asker C Hardness | 48 | 55 | 50 |
| | Compression Set | 47% | 46% | 37% |
| | (CS) | | | |
| | | Sample No. | | |
| | | 4 | 5 | 6 |
| | | Comparative | Comparative | Comparative |
| | | Example 4 | Example 5 | Example 6 |
| Formu- | TPS | 100 | 100 | 100 |
| lation | TPV | | | |
| (parts by | Chemical Foaming | | | |
| mass) | Agent | | | |
| | Low-temperature | | | 5 |
| | Expandable | | | |
| | Microcapsules (a) | | | |
| | High-temperature | 20 | 30 | 10 |
| | Expandable | | | |
| | Microcapsules (b) | | | |
| Note | a + b | 20 | 30 | 15 |
| | a/(a + b) | 0% | 0% | 33% |
| Property | Specific Gravity | 0.20 | 0.19 | 0.26 |
| | Asker C Hardness | 48 | 47 | 46 |
| | Compression Set | 38% | 37% | 38% |
| | (CS) | | | |
| | | Sample No. | | |
| | | 7 | | |
| | | Comparative | 8 | 9 |
| | | Example 7 | Example 1 | Example 2 |
| Formu- | TPS | 100 | 90 | 85 |
| lation | TPV | | 10 | 15 |
| (parts by | Chemical Foaming | | | |
| mass) | Agent | | | |
| | Low-temperature | 10 | 10 | 10 |
| | Expandable | | | |
| | Microcapsules (a) | | | |
| | High-temperature | 20 | 20 | 20 |
| | Expandable | | | |
| | Microcapsules (b) | | | |
| Note | a + b | 30 | 30 | 30 |
| | a/(a + b) | 33% | 33% | 33% |
| Property | Specific Gravity | 0.22 | 0.18 | 0.20 |
| | Asker C Hardness | 44 | 41 | 39 |
| | Compression Set | 40% | 34% | 34% |
| | (CS) | | | |
| | | Sample No. | | |
| | | 10 | 11 | 12 |
| | | Example 3 | Example 4 | Example 5 |
| Formu- | TPS | 80 | 70 | 60 |
| lation | TPV | 20 | 30 | 40 |
| (parts by | Chemical Foaming | | | |
| mass) | Agent | | | |
| | Low-temperature | 10 | 10 | 10 |
| | Expandable | | | |
| | Microcapsules (a) | | | |
| | High-temperature | 20 | 20 | 20 |
| | Expandable | | | |
| | Microcapsules (b) | | | |
| Note | a + b | 30 | 30 | 30 |
| | a/(a + b) | 33% | 33% | 33% |
| Property | Specific Gravity | 0.20 | 0.25 | 0.26 |
| | Asker C Hardness | 38 | 42 | 44 |
| | Compression Set | 31% | 30% | 29% |
| | (CS) | | | |

| | | Sample No. | |
|---|---|---|---|
| | | 13 | 14 |
| | | Comparative | Comparative |
| | | Example 8 | Example 9 |
| Formu- | TPS | 50 | 0 |
| lation | TPV | 50 | 100 |
| (parts by | Chemical Foaming | | |
| mass) | Agent | | |
| | Low-temperature | 10 | 0 |
| | Expandable | | |
| | Microcapsules (a) | | |
| | High-temperature | 20 | 10 |
| | Expandable | | |
| | Microcapsules (b) | | |
| Note | a + b | 30 | 10 |
| | a/(a + b) | 33% | 0% |
| Property | Specific Gravity | 0.34 | 0.54 |
| | Asker C Hardness | 53 | 66 |
| | Compression Set | 27% | 18% |
| | (CS) | | |

TABLE 2

| | | Sample No. | | |
|---|---|---|---|---|
| | | 15 | 16 | 17 |
| | | Comparative | Comparative | Comparative |
| | | Example 10 | Example 11 | Example 12 |
| Formu- | TPS | 80 | 80 | 80 |
| lation | TPV | 20 | 20 | 20 |
| (parts by | Low-temperature | | 5 | 7.5 |
| mass) | Expandable | | | |
| | Microcapsules (a) | | | |
| | High-temperature | | 10 | 15 |
| | Expandable | | | |
| | Microcapsules (b) | | | |
| Note | a + b | | 15 | 22.5 |
| | a/(a + b) | | 33% | 33% |
| Property | Specific Gravity | 0.91 | 0.26 | 0.18 |
| | Asker C Hardness | 98 | 52 | 48 |
| | Compression Set | 29% | 30% | 32% |
| | (CS) | | | |
| | | Sample No. | | |
| | | 18 | 19 | 20 |
| | | Example 6 | Example 7 | Example 8 |
| Formu- | TPS | 80 | 80 | 80 |
| lation | TPV | 20 | 20 | 20 |
| (parts by | Low-temperature | 7.5 | 10 | 15 |
| mass) | Expandable | | | |
| | Microcapsules (a) | | | |
| | High-temperature | 17.5 | 15 | 10 |
| | Expandable | | | |
| | Microcapsules (b) | | | |
| Note | a + b | 25 | 25 | 25 |
| | a/(a + b) | 30% | 40% | 60% |
| Property | Specific Gravity | 0.20 | 0.18 | 0.29 |
| | Asker C Hardness | 44 | 38 | 45 |
| | Compression Set | 31% | 31% | 31% |
| | (CS) | | | |
| | | Sample No. | | |
| | | 21 | | |
| | | Comparative | 22 | 23 |
| | | Example 13 | Example 9 | Example 10 |
| Formu- | TPS | 80 | 80 | 80 |
| lation | TPV | 20 | 20 | 20 |
| (parts by | Low-temperature | 2.5 | 5 | 10 |
| mass) | Expandable | | | |
| | Microcapsules (a) | | | |
| | High-temperature | 27.5 | 25 | 20 |
| | Expandable | | | |
| | Microcapsules (b) | | | |
| Note | a + b | 30 | 30 | 30 |
| | a/(a + b) | 8% | 17% | 33% |
| Property | Specific Gravity | 0.19 | 0.20 | 0.20 |
| | Asker C Hardness | 49 | 45 | 38 |
| | Compression Set | 30% | 32% | 31% |
| | (CS) | | | |
| | | Sample No. | | |
| | | | | 26 |
| | | 24 | 25 | Comparative |
| | | Example 11 | Example 12 | Example 14 |
| Formu- | TPS | 80 | 80 | 80 |
| lation | TPV | 20 | 20 | 20 |
| (parts by | Low-temperature | 15 | 20 | 22.5 |
| mass) | Expandable | | | |
| | Microcapsules (a) | | | |
| | High-temperature | 15 | 10 | 7.5 |
| | Expandable | | | |
| | Microcapsules (b) | | | |
| Note | a + b | 30 | 30 | 30 |
| | a/(a + b) | 50% | 67% | 75% |
| Property | Specific Gravity | 0.22 | 0.26 | 0.41 |
| | Asker C Hardness | 42 | 43 | 51 |
| | Compression Set | 31% | 31% | 31% |
| | (CS) | | | |
| | | Sample No. | | |
| | | 27 | | |
| | | Comparative | 28 | 29 |
| | | Example 15 | Example 13 | Example 14 |
| Formu- | TPS | 80 | 80 | 80 |
| lation | TPV | 20 | 20 | 20 |
| (parts by | Low-temperature | 25 | 13 | 17 |
| mass) | Expandable | | | |
| | Microcapsules (a) | | | |
| | High-temperature | 5 | 27 | 33 |
| | Expandable | | | |
| | Microcapsules (b) | | | |
| Note | a + b | 30 | 40 | 50 |
| | a/(a + b) | 83% | 33% | 34% |
| Property | Specific Gravity | 0.61 | 0.17 | 0.18 |
| | Asker C Hardness | 58 | 38 | 40 |
| | Compression Set | 31% | 32% | 32% |
| | (CS) | | | |

| | | Sample No. | |
|---|---|---|---|
| | | | 31 |
| | | 30 | Comparative |
| | | Example 15 | Example 16 |
| Formu- | TPS | 80 | 80 |
| lation | TPV | 20 | 20 |
| (parts by | Low-temperature | 33 | 20 |
| mass) | Expandable | | |
| | Microcapsules (a) | | |
| | High-temperature | 17 | 40 |
| | Expandable | | |
| | Microcapsules (b) | | |
| Note | a + b | 50 | 60 |
| | a/(a + b) | 66% | 33% |
| Property | Specific Gravity | 0.23 | 0.21 |
| | Asker C Hardness | 43 | 47 |
| | Compression Set | 31% | 36% |
| | (CS) | | |

Details of the materials used in the Examples are as follows.

The TPS used is trade name “Tefabloc T3779B” available from Mitsubishi Chemical Corporation. This product is an elastomer containing a styrenic rubber (styrene-butadiene copolymer (SBC)) as a base polymer.

The TPV used is trade name “Santoprene 8211-45” available from Exxon Mobil Corporation. This product is an elastomer containing vulcanized EPDM as a polyolefin base.

The chemical foaming agent used (in only samples 1 and 2) is trade name “Polythlene EV306G” available from EIWA CHEMICAL IND. CO., LTD. This product is an azodicarbonamide (ADCA)-based chemical foaming agent, and is in the form of a master batch composed of ethylene-vinyl acetate (EVA).

The low-temperature expandable microcapsules used are trade name “Microsphere F185EVA” available from Matsumoto Yushi-Seiyaku Co., Ltd. This product contains a shell formed of an acrylic resin, a hydrocarbon as a foaming component, and EVA as a master batch (foaming initiation temperature: 145 to 155° C., maximum expansion temperature: 190 to 200° C.)

The high-temperature expandable microcapsules used are trade name “Microsphere F190EVA” available from Matsumoto Yushi-Seiyaku Co., Ltd. This product contains a shell formed of an acrylic resin, a hydrocarbon (different from the aforementioned one) as a foaming component, and EVA as a master batch (foaming initiation temperature: 160 to 170° C., maximum expansion temperature: 210 to 220° C.)

Tables 1 and 2 include the total amount (parts by mass) of two foaming agents: low-temperature expandable microcapsules (a) and high-temperature expandable microcapsules (b); i.e., a+b, and the ratio of the amount of low-temperature expandable microcapsules to the total amount of the two foaming agents; i.e., a/(a+b) (% by mass) (see “Note” in the tables).

[Formation of Molded Resin Foam]

Subsequently, each of the above-prepared foamable resin compositions (samples 1 to 31) (composition temperature: 230° C.) was injected into a mold (temperature: 60° C.) at an injection speed of 120 mm/second (mold condition: short shot method), to thereby form (foam-mold) a molded resin foam (test piece) having a size of 60 mm×200 mm and a thickness of 6 mm.

Thus, the foam molding of the foamable resin compositions (samples 6 to 14 and 16 to 31) each containing the low-temperature expandable microcapsules and the high-temperature expandable microcapsules was performed at a temperature at which the high-temperature expandable microcapsules do not burst, but the low-temperature expandable microcapsules burst at least partially.

[Properties of Molded Resin Foam]

Subsequently, each of the resultant molded resin foams (samples 1 to 31) was analyzed for the following properties.

(1) Specific gravity

The specific gravity was measured according to JIS K 7222.

(2) Asker C hardness.

The hardness was measured with an Asker C hardness meter according to JIS K 7312.

(3) Compression set

According to JIS K 6400-4, the sample was compressed to 50% of its original thickness by method A (compression at 70° C.) and allowed to stand for 22 hours, and then decompressed and restored for 30 minutes, followed by measurement of the thickness and calculation of the compression set (CS).

The molded resin foams (samples 8 to 12, 18 to 20, 22 to 25, and 28 to 30), which exhibited a specific gravity of 0.3 or less, an Asker C hardness of 45 or less, and a compression set of 35% or less, and the foamable resin compositions used for these samples were regarded as Examples. Meanwhile, the molded resin foams (the samples other than the aforementioned ones) and the foamable resin compositions used for these samples were regarded as Comparative Examples.

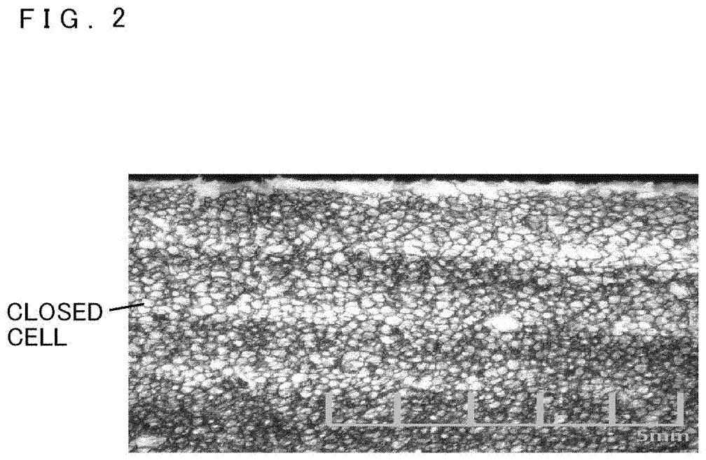

The molded resin foam (sample 5) of Comparative Example 5 had only closed cells (about 0.2 to 0.4 mm) formed of high-temperature expandable microcapsules, as shown in FIG. 2 (cross-section micrograph).

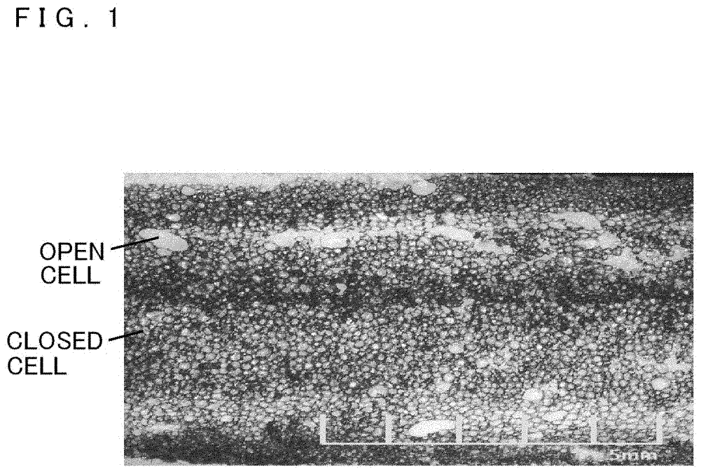

In contrast, the molded resin foam of each Example (e.g., sample 10 of Example 3) had both closed cells (about 0.2 to 0.4 mm) formed of high-temperature expandable microcapsules and open cells (about 0.6 to 1.0 mm) formed of burst low-temperature expandable microcapsules, as shown in FIG. 1 (cross-section micrograph).

The present invention is not limited to the aforementioned Examples, and may be appropriately modified and embodied without departing from the spirit of the invention.

1. A foamable resin composition comprising a styrenic thermoplastic elastomer and a dynamically crosslinked thermoplastic elastomer in a total amount of 100 parts by mass, wherein an amount of the dynamically crosslinked thermoplastic elastomer is 10 to 40 parts by mass, the composition further comprises high-temperature expandable microcapsules and low-temperature expandable microcapsules in a total amount of 25 to 50 parts by mass relative to 100 parts by mass of the elastomers, and an amount of the low-temperature expandable microcapsules is 17 to 67% by mass relative to the total amount of the two types of microcapsules.

2. A method for producing a molded resin foam, the method comprising molding a foamable resin composition containing a styrenic thermoplastic elastomer, a dynamically crosslinked thermoplastic elastomer, high-temperature expandable microcapsules, and low-temperature expandable microcapsules at a temperature at which the high-temperature expandable microcapsules do not burst, but the low-temperature expandable microcapsules burst at least partially.

3. A molded resin foam comprising a styrenic thermoplastic elastomer, a dynamically crosslinked thermoplastic elastomer, high-temperature expandable microcapsules, and low-temperature expandable microcapsules, wherein the high-temperature expandable microcapsules expand but do not burst; the low-temperature expandable microcapsules expand and burst at least partially; and the resin foam has a specific gravity of 0.3 or less, an Asker C hardness of 45 or less, and a compression set (JIS K 6400-4, method A, compressibility: 50%) of 35% or less.
